(19) United States
(12) Patent Application Publication
(10) Pub. No.: US 2025/0130392 A1
(43) Pub. Date: Apr. 24, 2025

(54) LENS UNIT AND IMAGE PICKUP APPARATUS

(71) Applicant: CANON KABUSHIKI KAISHA, Tokyo (JP)

(72) Inventor: KOSUKE NOZAKI, Chiba (JP)

(21) Appl. No.: 18/910,414

(22) Filed: Oct. 9, 2024

(30) Foreign Application Priority Data
Oct. 24, 2023 (JP) 2023-182224

(51) Int. Cl. G02B 7/02

(52) U.S. Cl. CPC G02B 7/022; G02B 7/025; G02B 7/026

(57) ABSTRACT

A lens unit includes a holding member that holds a lens on an inner circumference side, a pressing member that is disposed on an inner circumference of the holding member, contacts a contact surface of the holding member from an optical axis direction, is fixed to the holding member by a fixing member, and thereby presses the lens against the holding member from the optical axis direction. The holding member has a first concave portion that is concave toward an outside in a radial direction at at least one location in a circumferential direction. The pressing member has a second concave portion that is concave toward an inside in the radial direction at at least one location in the circumferential direction. The fixing member is disposed in an area facing the first concave portion, the second concave portion, and the contact surface.

### BACKGROUND

### Technical Field

The disclosure relates to an image pickup apparatus, such as an on-board camera and a surveillance camera.

### Description of Related Art

The image pickup apparatuses, which are often used in outdoor environments as described above, are demanded to have impact resistance against external forces.

Japanese Patent Laid-Open No. 2020-27284 discloses a lens module including a first lens provided on the object side, and a fixing member that holds the first lens by pressing it against the front end of a lens barrel from the object side. The lens barrel is adhered to and fixed to the fixing member. Japanese Patent Application Laid-Open No. 2020-27278 discloses a lens module including a lens provided on the object side, and a fixing member that presses the lens against the front end of the lens barrel from the object side to fix it. An adhesive is filled between the lens and a contact portion of the fixing member that contacts the lens.

In order to improve impact resistance, it is effective to adhere the lens to the fixing member. However, the structure of Japanese Patent Laid-Open No. 2020-27284 presumes that the fixing member is fixed to the outer circumference portion of the lens barrel, and the size of the lens module increases by the radial size of the fixing member. In the structure of Japanese Patent Laid-Open No. 2020-27278, the adhesive is applied between the fixing member and the lens, it is necessary to assemble the lens so that the adhesive does not spread into the optical effective area of the lens, and the assembly is not easy.

### SUMMARY

A lens unit according to one aspect of the disclosure includes a holding member that holds a lens on an inner circumference side, a pressing member that is disposed on an inner circumference of the holding member, contacts a contact surface of the holding member from an optical axis direction, is fixed to the holding member by a fixing member, and thereby presses the lens against the holding member from the optical axis direction. The holding member has a first concave portion that is concave toward an outside in a radial direction at at least one location in a circumferential direction. The pressing member has a second concave portion that is concave toward an inside in the radial direction at at least one location in the circumferential direction. The fixing member is disposed in an area facing the first concave portion, the second concave portion, and the contact surface. An image pickup apparatus having the above lens unit also constitutes another aspect of the disclosure.

Further features of the disclosure will become apparent from the following description of embodiments with reference to the attached drawings.

### BRIEF DESCRIPTION OF THE DRAWINGS

FIGS. 1A, 1B, and 1C are a rear view and sectional views of a lens unit according to Example 1.

FIG. 2 is a sectional view of the imaging unit according to Example 1.

FIG. 3 is an exploded perspective view of the imaging unit according to Example 1 viewed from an object side.

FIG. 4 is an exploded perspective view of the imaging unit according to Example 1 viewed from an image side.

FIG. 5 is a perspective view of the camera according to Example 1.

FIGS. 6A, 6B, and 6C are a rear view and sectional views of a lens unit according to Example 2.

FIG. 7 is a sectional view of the imaging unit according to Example 2.

### DETAILED DESCRIPTION

Referring now to the accompanying drawings, a description will be given of examples according to the present disclosure.

### Example 1

An image pickup apparatus according to Example 1 is particularly suitable for on-board (in-vehicle) cameras and surveillance cameras that are used in outdoor environments. However, the image pickup apparatus according to the example of the present disclosure also includes an apparatus that is used indoors.

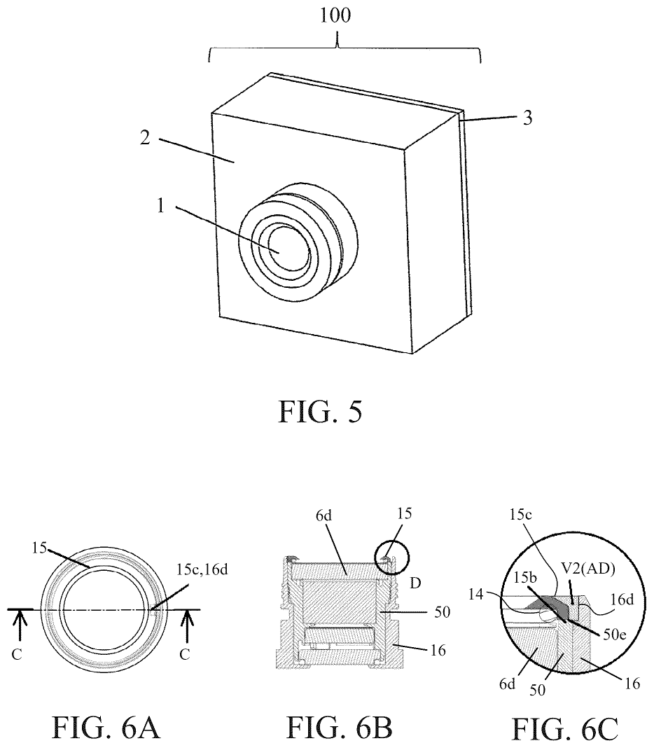

FIG. 5 illustrates the appearance of a camera 100 according to this example. The camera 100 includes an imaging unit 1 as an image pickup apparatus, and an exterior member 2 that holds it. A portion on the imaging surface side of the imaging unit 1 is housed in the exterior member 2 and fixed to the exterior member 2 with unillustrated screws, and a portion on the object side of the imaging unit 1 is exposed from an opening provided in the front of the exterior member 2. A gap between the opening of the exterior member 2 and the outer circumference portion of the imaging unit 1 is sealed with an unillustrated sealing member, and thereby water and dust are prevented from entering through the gap.

A cover 3 is fixed to the back of the exterior member 2 with unillustrated screws. The exterior member 2 and the cover 3 are sandwiched with an unillustrated sealing member, and thereby water and dust can be prevented from entering through the gap between the exterior member 2 and the cover 3. In addition, the cover 3 is provided with an unillustrated external interface. By connecting a cable to this external interface, a video signal generated by imaging using the imaging unit 1 can be output to the outside. The external interface may have a wireless communication function for video signals.

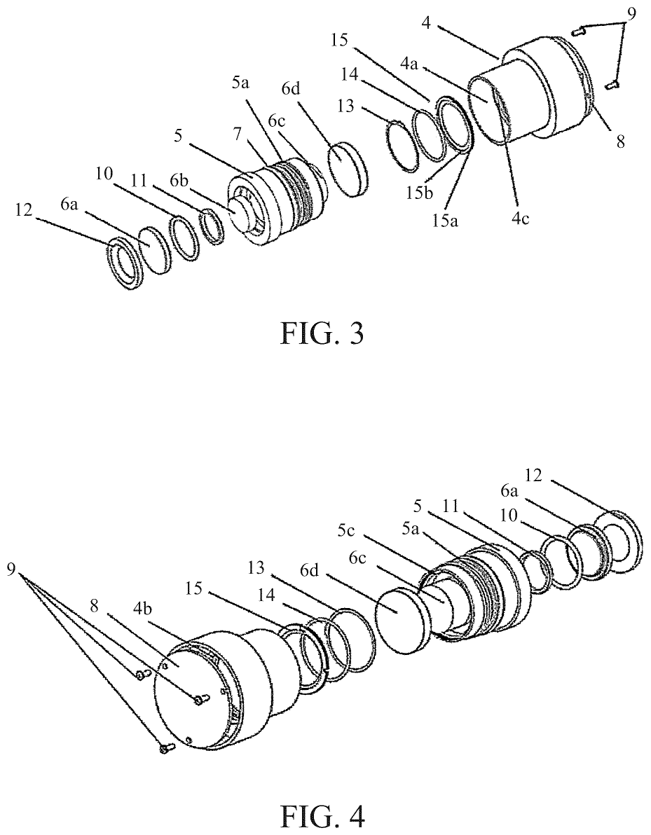

FIG. 2 illustrates the internal structure of the imaging unit 1. FIG. 3 illustrates an exploded view of the imaging unit 1 viewed from the object side. FIG. 4 illustrates an exploded view of the imaging unit 1 viewed from the image surface side (referred to as a sensor side hereinafter). An alternate long and short dash line in FIG. 2 indicates an optical axis, and in the following description, a direction in which the optical axis extends will be referred to as an optical axis direction, a direction perpendicular to the optical axis will be referred to as a radial direction, and a direction around the optical axis will be referred to as a circumferential direction.

A housing 4 has an opening 4a on the object side, an opening 4b on the sensor side, and an inner-circumference threaded portion 4c provided on the inner circumference portion, and holds the lens unit 30 on its inner circumference side. The lens unit 30 includes a lens frame 5, and lenses 6a, 6b, 6c, and 6d. The lens unit 30 is inserted into the opening 4a, and is held by the housing 4 by screwing an outer-circumference threaded portion 5a provided on the outer circumference portion of the lens frame 5 into the inner-circumference threaded portion 4c provided on the inner circumference portion of the housing 4.

For weather resistance in outdoor use, the housing 4 and the lens frame 5 may be made of metal. A circumferential groove portion 5b is formed in the outer circumference portion of the lens frame 5 on the object side of the outer-circumference threaded portion 5a, and an elastic body (second seal member) 7 such as an O-ring is fitted into the circumferential groove portion 5b. The elastic body 7 seals a gap between the outer circumference portion of the lens frame 5 and the inner circumference portion of the housing 4 to prevent water and dust from entering through the gap between them.

The sensor unit 8 includes an image sensor 8a such as a CMOS sensor. The sensor unit 8 is placed inside the opening 4b of the housing 4, and is fixed to a receiver provided in the opening 4b with a screw 9. Thus, the sensor unit 8 is held by the housing 4 together with the lens unit 30. As described above, the outer-circumference threaded portion 5a of the lens unit 30 is screwed into the inner-circumference threaded portion 4c of the housing 4, and the position of the lens unit 30 in the optical axis direction relative to the sensor unit 8 can be adjusted by rotating the lens unit 30 around the optical axis relative to the housing 4.

In the lens unit 30, the lens frame 5 as a holding member (holder) holds the lenses 6a to 6d on its inner circumference side. An opening is formed at each of the end of the object side and the end of the sensor side of the lens frame 5. The lens 6b, the spacer 11, the elastic body 10 such as an O-ring, and the lens 6a are inserted into the inner circumference portion of the lens frame 5 in this order from the object side opening. A front pressing ring 12 is fixed to the lens frame 5 and contacts the lens 6a disposed closest to the object by screwing the unillustrated outer-circumference threaded portion on the outer circumference portion of the front pressing ring 12 into the unillustrated inner-circumference threaded portion on the inner circumference portion of the lens frame 5. Thereby, the elastic body 10 is sandwiched between the lens 6a and the lens frame 5, and the gap is sealed between the lens 6a and the lens frame 5 and water and dust are prevented from entering through the gap.

The lens 6c is inserted into the inner circumference portion of the lens frame 5 from the opening on the sensor side, and is fixed to the lens frame 5 by adhesive as a fixing member. The lens 6d, the fixing plate 13, and an elastic body (elastic member) 14 such as an O-ring are inserted in this order into the inner circumference portion of the lens frame 5 from the opening on the sensor side. A rear pressing ring 15 as a pressing member is fixed to the lens frame 5 and contacts the elastic body 14 by having an outer-circumference threaded portion 15a provided on the outer circumference portion of the rear pressing ring 15 screwed into an inner-circumference threaded portion 5c provided on the inner circumference portion of the lens frame 5.

The rear pressing ring 15 screws into the lens frame 5 until its contact surface 15b contacts the contact surface 5e of the lens frame 5. Thereby, the elastic body 14 is sandwiched between the rear pressing ring 15 and the fixing plate 13, and the rear pressing ring 15 is held by the lens frame 5 in a state in which the lens 6d closest to the image sensor is biased toward the object side by the elastic force of the elastic body 14. In this structure, the lens 6d is pressed against the lens frame 5 with a force lower than that in a case where the rear pressing ring 15 presses the lens 6d directly toward the object side. This structure can suppress deformation of the lens surface of the lens 6d, and prevent deterioration of optical performance. As long as the deformation of the lens surface of the lens 6d is suppressed, the lens 6d may be held by the lens frame 5 and the rear pressing ring 15 may directly contact the lens 6d.

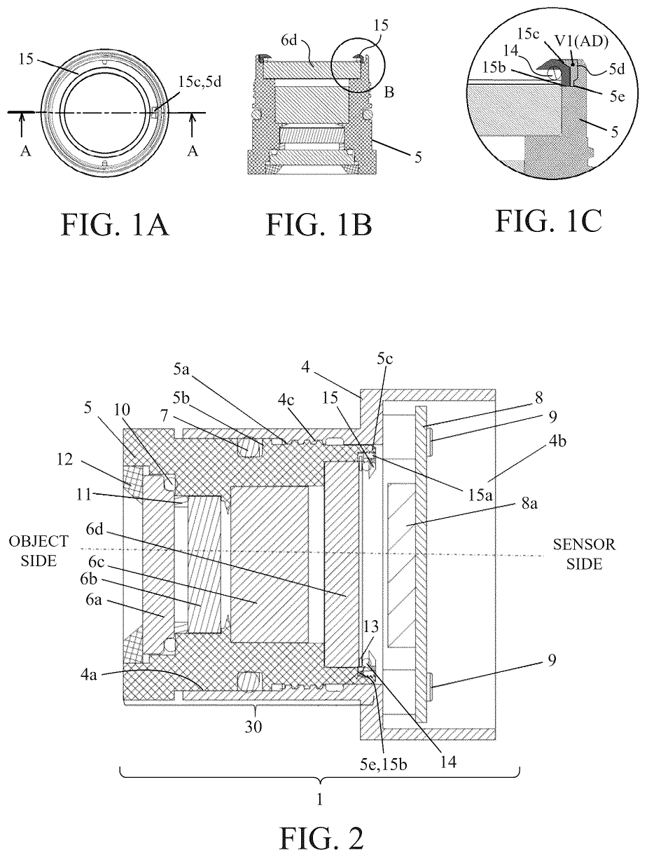

FIG. 1A illustrates the lens unit 30 viewed from the sensor side. FIG. 1B illustrates an A-A section in FIG. 1A. FIG. 1C illustrates an enlarged view of an area B in FIG. 1B.

A notch portion 5d is formed at one circumference location of the inner-circumference threaded portion 5c of the lens frame 5 as a first concave portion that is concave toward the outside in the radial direction. A circumferential surface within the notch portion 5d is an arc surface (part of a cylindrical surface) extending in the optical axis direction. On the other hand, a notch portion 15c is formed as a second concave portion that is concave toward the inside in the radial direction at one circumference location on the outer-circumference threaded portion 15a of the rear pressing ring 15. A portion on the object side of the circumferential surface in the notch portion 15c is an arc surface extending in the optical axis direction, and a portion on its sensor side is a tilted surface (truncated cone surface) that is tilted relative the optical axis direction so as to be closer to the optical axis at a position closer to the image sensor.

In a state where the rear pressing ring 15 is assembled to the lens frame 5 by screwing, the notch portions 15c and 5d face each other in the radial direction, that is, they are positioned so as to be in the same phase in the circumferential direction. The contact surface 5e is exposed toward the sensor side between the notch portions 15c and 5d. As a result, space (area) V1 is formed that faces the notch portion 15c, the notch portion 5d, and the contact surface 5e and opens toward the sensor side. An adhesive AD is placed in this space V1. Thereby, the rear pressing ring 15 (notch portion 15c) is adhered and fixed to the lens frame 5 (notch portion 5d and contact surface 5e).

By providing a slope to the notch portion 15c, a width in the radial direction of the opening on the sensor side of the space V1 increases, and the workability is improved in filling the adhesive in the space V1. At least one of the notch portions 15c and 5d may be formed so that the width in the radial direction of the space V1 increases toward the sensor side (side opposite the contact surface 5e in the optical axis direction).

This example uses the fixing with adhesive, but can fix the space V1 by filling it with an elastic body such as a sealant without using adhesive.

The length of the notch portion in the circumferential direction of either the notch portion 5d or the notch portion 15c may be longer than that of the other. Thereby, even if the phases of the notch portions 5d and 15c are slightly shifted due to manufacturing variations of the components, the lengths in the circumferential direction of the notch portions 15c and 5d facing each other to form the space V1 can be sufficiently secured, and good adhesive strength can be obtained. The notch portions 15c and 5d may be provided at a plurality of locations in the circumferential direction of the rear pressing ring 15 and the lens frame 5, respectively.

Thus, this example screws the rear pressing ring 15 into the lens frame 5, reduces the size of the lens unit 30, and forms an adhesive reservoir (space V1) for fixing the rear pressing ring 15 to the lens frame 5 using the adhesive. Thereby, the adhesive AD for adhering the rear pressing ring 15 can be adhered to the lens frame 5 without moving to the lens surface of the lens 6d. In other words, a lens unit can be provided that has good assembly performance (adhesion workability) and suppresses a size increase in the radial direction of the lens unit 30.

In this example, the holding structure of the rear pressing ring 15 holds the lens 6d closest to the image sensor, but a similar holding structure may also be applied to the front pressing ring 12 that holds the lens 6a closest to the object.

### Example 2

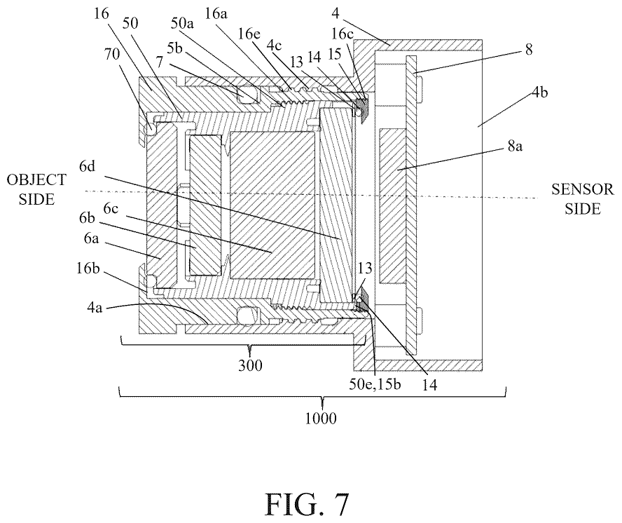

A description will now be given of Example 2. FIG. 7 illustrates the internal structure of an imaging unit 1000 according to Example 2. Those elements in this example, which are corresponding elements in Example 1, will be designated by the same reference numerals, and a description thereof will be omitted. In this example, the lens unit 300, which has a structure different from the lens unit 30 in Example 1, will be mainly described.

The lens unit 300 includes a lens frame 50 as a first holding member to which the lenses 6a to 6d are directly fixed and held, and an outer frame 16 as a second holding member that holds the lens frame 50 on the inner circumference side. Openings are provided at the end on the object side and the end on the sensor side of each of the lens frame 50 and the outer frame 16.

The lens frame 50 is made of resin, and the outer frame 16 may be made of metal. Since the lens frame 50 is a resin component, the lenses 6a to 6d can be pressed into and held by the inner circumference portion of the lens frame 50. Therefore, the lenses can be held with positional accuracy higher than that of Example 1, in which the lens frame 5 is a metal component. By holding the lens frame 50 with the metal outer frame 16, the lens frame 50 is prevented from being directly exposed to the outdoor environment such as sunlight, and the weather resistance of the lens unit 300 can be improved.

The lens unit 300 is inserted into the opening 4a of the housing 4, and is held by the housing 4 since the outer-circumference threaded portion 16e provided on the outer circumference portion of the outer frame 16 screws into the inner-circumference threaded portion 4c of the housing 4.

The lens frame 50 holds the lenses 6a to 6d on its inner circumference. The lenses 6b and 6a are inserted into the inner circumference of the lens frame 50 in this order from the opening on the object side. The lenses 6a and 6b are fixed and held by the lens frame 50 by thermal caulking. An elastic body (first seal member) 70 such as an O-ring is disposed within a stepped portion provided on the object side of the outer circumference portion of the lens 6a.

The lens 6c is inserted into the inner circumference of the lens frame 50 from the opening on the sensor side. The lens 6c is fixed and held by the lens frame 50 by thermal caulking. An outer-circumference threaded portion 50a is formed on the outer circumference portion of the lens frame 50. The lens frame 50 is held by the outer frame 16 by screwing the outer-circumference threaded portion 50a into an inner-circumference threaded portion 16a received on the inner circumference portion of the outer frame 16.

At this time, an elastic body 70 is sandwiched between a flange portion 16b formed as a protrusion portion that protrudes toward the inside in the radial direction at the front end of the outer frame 16 (on the object side of the lens 6a disposed closest to the object) and the lens 6a held by the lens frame 50. This structure seals the gap between the flange portion 16b and the lens 6a, and prevents water and dust from entering through the gap.

The lens 6d, the fixing plate 13, the elastic body 14, and the rear pressing ring 15 as a pressing member are inserted in this order from the opening on the sensor side into the inner circumference of the outer frame 16 that holds the lens frame 50. The rear pressing ring 15 is held by the outer frame 16 and contacts the elastic body 14, by screwing an outer-circumference threaded portion 15a provided on the outer circumference portion of the rear pressing ring 15 into an inner-circumference threaded portion 16c provided on the inner circumference portion of the outer frame 16.

The rear pressing ring 15 is screwed into the outer frame 16 until its contact surface 15b contacts the contact surface 50e of the lens frame 50. Thereby, similarly to Example 1, the elastic body 14 is sandwiched between the rear pressing ring 15 and the fixing plate 13, and the rear pressing ring 15 is held by the outer frame 16 in a state in which the lens 6d closest to the sensor is biased toward the object side by the elastic force of the elastic body 14. In this structure, the lens 6d is pressed against the lens frame 50 with a force lower than that in a case where the rear pressing ring 15 directly presses against the lens frame 50 toward the object side. Thus, this structure can suppress deformation of the lens surface of the lens 6d, and prevent a decrease in optical performance. As long as the deformation of the lens surface of the lens 6d is suppressed, the lens 6d may be held by the lens frame 50 while the rear pressing ring 15 directly contacts the lens 6d.

FIG. 6A illustrates the lens unit 300 viewed from the sensor side, and FIG. 6B illustrates a section taken along a line C-C in FIG. 6A. FIG. 6C illustrates an enlarged view of an area D in FIG. 6B.

A notch portion 16d is formed in one circumference location of the inner-circumference threaded portion 16c of the outer frame 16 as a first concave portion that is concave toward the outside in the radial direction. A circumferential surface within the notch portion 16d is an arc surface (part of a cylindrical surface) extending in the optical axis direction. Similarly to Example 1, the notch portion 15c is formed in one circumference location of the outer-circumference threaded portion 15a of the rear pressing ring 15 as a second concave portion that is concave toward the inside in the radial direction. A portion on the object side of the circumferential surface within the notch portion 15c is an arc surface extending in the optical axis direction, and a portion on the sensor side is a tilted surface.

In a state where the rear pressing ring 15 is screwed into the outer frame 16, the notch portions 15c and 16d are positioned so as to face each other in the radial direction (in the same phase in the circumferential direction). The contact surface 50e of the lens frame 50 is exposed toward the sensor side between the notch portions 15c and 16d. As a result, space (area) V2 is formed that faces the notch portion 15c, the notch portion 16d, and the contact surface 50e, and opens toward the sensor side. An adhesive AD is placed in this space V2. Thereby, the rear pressing ring 15 (notch portion 15c) is adhered to and fixed to the outer frame 16 (notch portion 16d) and the lens frame 50 (contact surface 50e).

This example provides the notch portion 15c with a slope, increases the width in the radial direction of the opening on the sensor side of the space V2, and improves the workability in filling the space V2 with adhesive. At least one of the notch portions 15c and 16d may be formed so that the width in the radial direction of the space V2 becomes wider toward the sensor side (the side opposite to the contact surface 50e in the optical axis direction).

Regarding the length of the notch portion in the circumferential direction, either the notch portion 16d or the notch portion 15c may be longer than that of the other. Thereby, even if the phases of the notch portions 16d and 15c are slightly shifted due to manufacturing variations of the components, the lengths in the circumferential direction of the notch portions 16d and 15c facing each other to form the space V2 can be sufficiently secured, and good adhesive strength can be obtained. The notch portions 15c and 16d may be provided at a plurality of locations in the circumferential direction of the rear pressing ring 15 and the outer frame 16, respectively. This example screws the rear pressing ring 15 into the outer frame 16, reduces the size of the lens unit 300, and forms an adhesive reservoir (space V2) for adhering the rear pressing ring 15 to the outer frame 16 and the lens frame 50. Thereby, the adhesive can adhere the rear pressing ring 15 to the outer frame 16 and the lens frame 50 by preventing the adhesive for adhering the rear pressing ring 15 from moving to the lens surface of the lens 6d. In other words, a lens unit can be provided that has good assembly performance (adhesion workability) and suppresses a size increase in the radial direction of the lens unit 300.

Examples 1 and 2 use a holding structure in which the rear pressing ring 15 is screwed into the lens frame 5 or outer frame 16, but may use another holding structure such as a bayonet connection.

Each example can provide a lens unit that is easy to assemble while suppressing an increase in radial size, and an image pickup apparatus including the same.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

Each example can provide a lens unit that is easy to assemble while suppressing a size increase in a radial direction, and an image pickup apparatus having the same.

This application claims priority to Japanese Patent Application No. 2023-182224, which was filed on Oct. 24, 2023, and which is hereby incorporated by reference herein in its entirety.

What is claimed is:

1. A lens unit comprising:
a holding member that holds a lens on an inner circumference side; and
a pressing member that is disposed on an inner circumference of the holding member, contacts a contact surface of the holding member from an optical axis direction, is fixed to the holding member by a fixing member, and thereby presses the lens against the holding member from the optical axis direction,
wherein the holding member has a first concave portion that is concave toward an outside in a radial direction at at least one location in a circumferential direction,
wherein the pressing member has a second concave portion that is concave toward an inside in the radial direction at at least one location in the circumferential direction, and
wherein the fixing member is disposed in an area facing the first concave portion, the second concave portion, and the contact surface.

2. The lens unit according to claim 1, wherein the fixing member is an adhesive.

3. The lens unit according to claim 2, wherein the holding member has an inner-circumference threaded portion,
wherein the pressing member has an outer-circumference threaded portion, and
wherein the pressing member is assembled to the holding member by screwing the outer-circumference threaded portion into the inner-circumference threaded portion until the pressing member contacts the contact surface, and is fixed to the holding member by the adhesive.

4. The lens unit according to claim 2, wherein the holding member includes a first holding member to which the lens is fixed, and a second holding member that holds the first holding member on an inner circumference side,
wherein the pressing member contacts the contact surface provided on the first holding member, and is fixed to the first holding member and the second holding member by the adhesive, and
wherein the first concave portion is provided on the second holding member.

5. The lens unit according to claim 4, wherein the second holding member has an inner-circumference threaded portion,
wherein the pressing member has an outer-circumference threaded portion, and
wherein the pressing member is assembled to the second holding member by screwing the outer-circumference threaded portion into the inner-circumference threaded portion until the pressing member contacts the contact surface, and is fixed to the first holding member and the second holding member by the adhesive.

6. The lens unit according to claim 4, wherein the second holding member has a protruding portion that protrudes toward the inside in the radial direction on the object side of a lens disposed closest to an object among lenses held by the first holding member, and
wherein a first seal member is disposed between the protruding portion and the lens disposed closest to the object.

7. The lens unit according to claim 3, wherein the first concave portion is provided at at least one location in the circumferential direction of the inner-circumference threaded portion, and
wherein the second concave portion is provided at at least one location in the circumferential direction of the outer-circumference threaded portion.

8. The lens unit according to claim 1, wherein at least one of the first concave portion and the second concave portion is formed such that a width in the radial direction of the area increases toward a side opposite the contact surface in the optical axis direction.

9. The lens unit according to claim 1, wherein at least one of the first concave portion and the second concave portion has a length in the circumferential direction longer than that of the other of the first concave portion and the second concave portion.

10. The lens unit according to claim 1, wherein an elastic member is disposed between the pressing member and the lens, and
wherein the pressing member presses the lens against the holding member via the elastic member.

11. An image pickup apparatus comprising:
a lens unit; and
an image sensor configured to image an object through the lens unit,
where the lens unit includes:
a holding member that holds a lens on an inner circumference side; and
a pressing member that is disposed on an inner circumference of the holding member, contacts a contact surface of the holding member from an optical axis direction, is fixed to the holding member by a fixing member, and thereby presses the lens against the holding member from the optical axis direction,
wherein the holding member has a first concave portion that is concave toward an outside in a radial direction at at least one location in a circumferential direction,
wherein the pressing member has a second concave portion that is concave toward an inside in the radial direction at at least one location in the circumferential direction, and
wherein the fixing member is disposed in an area facing the first concave portion, the second concave portion, and the contact surface.

12. The image pickup apparatus according to claim 11, further comprising a housing that holds the lens unit and the image sensor on an inner circumference side,
wherein the lens unit is held by the housing so that a position of the lens unit can be adjusted in the optical axis direction relative to the image sensor.

13. The image pickup apparatus according to claim 12, wherein a second seal member is disposed between an inner circumference portion of the housing and an outer circumference portion of the holding member.
